(19) United States
(12) Patent Application Publication
(10) Pub. No.: US 2026/0048646 A1
(43) Pub. Date: Feb. 19, 2026

(54) LOAD PATH REINFORCEMENT ASSEMBLY CONFIGURED FOR USE IN ELECTRIC-, HYBRID-, AND INTERNAL-COMBUSTION-ENGINE-POWERED VEHICLES

(71) Applicant: FCA US LLC, Auburn Hills, MI (US)

(72) Inventors: Wei Wei, Auburn Hills, MI (US); Sumeet S. Kale, Pune (IN); Zheng Qin, Auburn Hills, MI (US); Prashanth G, Bangalore (IN); Hassan E-Hor, Auburn Hills, MI (US); Vikas V. Joshi, Pune (IN)

(21) Appl. No.: 18/805,642

(22) Filed: Aug. 15, 2024

(51) Int. Cl. B60K 1/04; B60K 6/28; B62D 21/02; B62D 25/02; B62D 25/20

(52) U.S. Cl. CPC B60K 1/04; B60K 6/28; B62D 21/02; B62D 25/025; B62D 25/2036; B60K 2001/0438

(57) ABSTRACT

A load path reinforcement system that is configured to direct the energy received by a sill during a side-impact to the vehicle to prevent or at least minimize a tunnel panel and cross-members from deforming and contacting a battery pack during the side-impact to the vehicle.

### FIELD

The present disclosure relates to a load-path reinforcement assembly that is configured for use in electric-, hybrid-, and internal-combustion-engine powered vehicles.

### BACKGROUND

This section provides background information related to the present disclosure which is not necessarily prior art.

Vehicles including an internal combustion engine (ICE) or hybrid propulsion systems include vehicle frames having load path structures that may be different from a vehicle that only has a battery-powered propulsion system. In this regard, vehicles having an internal combustion engine include powertrain components (e.g., transmission, driveshafts, and the like) that require a “tunnel” structure that extends down a length of the vehicle to accommodate these components that is not necessary in an electric vehicle. It is undesirable, however, from a research and development and cost standpoint to develop and manufacture separate vehicle frames for the same model of vehicle based on which propulsion system is selected for the model.

Moreover, even if the same vehicle frame is used for the same vehicle model regardless of the propulsion system selected for the vehicle, it should be understood that the load path structure for the vehicle frame may be acceptable for use with an ICE propulsion system, but may not be acceptable for use with a battery-powered electric vehicle. More particularly, the load paths may absorb and direct energy during the event of a collision that may negatively affect the integrity of the battery.

Accordingly, there is a desire for a body-in-white (BIW) frame structure that can be used in any type of vehicle regardless of the propulsion system selected for the vehicle that includes a load path structure that will not negatively affect the integrity of the battery if the vehicle includes a battery-powered propulsion system.

### SUMMARY

This section provides a general summary of the disclosure, and is not a comprehensive disclosure of its full scope or all of its features.

According to a first aspect of the present disclosure there is provided a vehicle that includes a propulsion system including at least one battery pack; a frame system configured to support the at least one battery pack, wherein the frame system includes a pair of primary frame members that each longitudinally extend along at least a portion of a length of the vehicle, a pair of sills that are positioned laterally outward from the pair of primary frame members and longitudinally extend along at least the portion of the length of the vehicle, a first cross-member, a second cross-member, a third cross-member, and a fourth cross-member that each extend between a respective sill and a respective primary frame member, the first to fourth cross-members being configured to direct energy received by the respective sill during a side-impact to the vehicle to the respective primary frame member, and a tunnel panel that longitudinally extends along the pair of primary frame members and connects the pair of primary frame members; and a load path reinforcement system that reinforces the first to fourth cross-members and the tunnel panel during the side-impact to the vehicle, wherein the load path reinforcement system includes at least one tunnel reinforcement assembly configured to maintain structural integrity of the tunnel panel during the side-impact to the vehicle, and a plurality of bracket assemblies that each include a first bracket and a second bracket, one of the first brackets being positioned between the tunnel panel and the first cross-member and another of the first brackets being positioned between the tunnel panel and the second cross-member, one of the second brackets being positioned between the first cross-member and one of the sills, and another of the second brackets being positioned between the second cross-member and the one of the sills, wherein the at least one battery pack is provided between one of the primary frame members and one of the sills, and the load path reinforcement system is configured to direct the energy received by the respective sill during the side-impact to the vehicle to prevent or at least minimize the tunnel panel and cross-members from deforming and contacting the battery pack during the side-impact to the vehicle.

According to the first aspect, the tunnel panel includes a first end, an opposite second end, an upper wall that extends the first end and the opposite second end, pair of sidewalls connected to the upper wall that extend between the first end and an opposite second end, an outer surface, and an inner surface.

According to the first aspect, the at least one tunnel reinforcement assembly includes a first tunnel reinforcement assembly having a first reinforcement member attached to the inner surface of the tunnel panel, a pair of second reinforcement members that overlap opposing ends of the first reinforcement member, and a third reinforcement member that overlaps the first reinforcement member and the second reinforcement members.

According to the first aspect, the first tunnel reinforcement assembly is attached to the inner surface of the tunnel panel at a location that is positioned between the third cross-member and the fourth cross-member.

According to the first aspect, the first reinforcement member extends between and is attached to the sidewalls of the tunnel panel by a pair of first flanges that are angled to align and abut with the sidewalls of the tunnel panel, a pair of first rails extend between the first flanges that are each configured to abut the upper wall of the tunnel panel, and an opposite side of the first rails defines a pocket.

According to the first aspect, the second reinforcement members each include a second flange that is angled to align with and abut against one of the first flanges of the first reinforcement member, and a pair of second rails that are configured to seat within the pockets that are formed opposite the first rails of the first reinforcement member.

According to the first aspect, the third reinforcement member overlaps the second reinforcement members such that second reinforcement members are sandwiched between first reinforcement member and the third reinforcement member, the third reinforcement member having a wedge-shaped body including a plurality of outwardly extending third flanges that are provided at opposing ends of the wedge-shaped body that are configured to abut against the second flanges of the second reinforcement member, and a pair of outwardly extending fourth flanges that extend outward from angled side surfaces of the wedge-shaped body that are configured to abut against the first reinforcement member.

According to the first aspect, the third reinforcement member is at least one of welded, brazed, adhered, or fastened to each of the second reinforcement members and the first reinforcement member.

According to the first aspect, the at least one tunnel reinforcement assembly includes a second tunnel reinforcement assembly having a pair of first brace members that are attached to the inner surface of the tunnel panel, and a second brace member that overlaps the pair of first brace members.

According to the first aspect, the second tunnel reinforcement assembly is attached to the inner surface of the tunnel panel at a location that is positioned between the first cross-member and the second cross-member.

According to a second aspect of the present disclosure, there is provided a method of manufacturing a vehicle that may include providing a frame system including a pair of sills, a tunnel panel provided between the pair of sills, and a plurality of cross-bar member assemblies between each of the sills and the tunnel panel; determining whether the vehicle will be electrically powered by a battery pack or powered by an internal combustion engine; and after determining whether the vehicle will be electrically powered or power powered by an internal combustion engine, determining whether to install a load-path reinforcement system on the tunnel panel to reinforce the tunnel panel in the event of a side impact to the vehicle, wherein the load-path reinforcement system is installed on the tunnel panel when the vehicle is electrically powered and includes the battery pack.

According to the second aspect, the plurality of cross-bar member assemblies includes a first cross-member, a second cross-member, a third cross-member, and a fourth cross-member that each extend between a respective sill and the tunnel panel, the first to fourth cross-members being configured to direct energy received by the respective sill during a side-impact to the vehicle to the tunnel panel, and the load path reinforcement system includes: at least one tunnel reinforcement assembly configured to maintain structural integrity of the tunnel panel during the side-impact to the vehicle, and a plurality of bracket assemblies that each include a first bracket and a second bracket, one of the first brackets being positioned between the tunnel panel and the first cross-member and another of the first brackets being positioned between the tunnel panel and the second cross-member, one of the second brackets being positioned between the first cross-member and one of the sills, and another of the second brackets being positioned between the second cross-member and the one of the sills, wherein the battery pack is provided between the tunnel panel and one of the sills, and the load path reinforcement system is configured to direct the energy received by the respective sill during the side-impact to the vehicle to prevent or at least minimize the tunnel panel and cross-members from deforming and contacting the battery pack during the side-impact to the vehicle.

According to the second aspect, the tunnel panel includes a first end, an opposite second end, an upper wall that extends the first end and the opposite second end, pair of sidewalls connected to the upper wall that extend between the first end and an opposite second end, an outer surface, and an inner surface.

According to the second aspect, the at least one tunnel reinforcement assembly includes a first tunnel reinforcement assembly having a first reinforcement member attached to the inner surface of the tunnel panel, a pair of second reinforcement members that overlap opposing ends of the first reinforcement member, and a third reinforcement member that overlaps the first reinforcement member and the second reinforcement members.

According to the second aspect, the first tunnel reinforcement assembly is attached to the inner surface of the tunnel panel at a location that is positioned between the third cross-member and the fourth cross-member.

According to the second aspect, the first reinforcement member extends between and is attached to the sidewalls of the tunnel panel by a pair of first flanges that are angled to align and abut with the sidewalls of the tunnel panel, a pair of first rails extend between the first flanges that are each configured to abut the upper wall of the tunnel panel, and an opposite side of the first rails defines a pocket.

According to the second aspect, wherein the second reinforcement members each include a second flange that is angled to align with and abut against one of the first flanges of the first reinforcement member, and a pair of second rails that are configured to seat within the pockets that are formed opposite the first rails of the first reinforcement member.

According to the second aspect, the third reinforcement member overlaps the second reinforcement members such that second reinforcement members are sandwiched between first reinforcement member and the third reinforcement member, the third reinforcement member having a wedge-shaped body including a plurality of outwardly extending third flanges that are provided at opposing ends of the wedge-shaped body that are configured to abut against the second flanges of the second reinforcement member, and a pair of outwardly extending fourth flanges that extend outward from angled side surfaces of the wedge-shaped body that are configured to abut against the first reinforcement member.

According to the second aspect, the at least one tunnel reinforcement assembly includes a second tunnel reinforcement assembly having a pair of first brace members that are attached to the inner surface of the tunnel panel, and a second brace member that overlaps the pair of first brace members.

According to the second aspect, the second tunnel reinforcement assembly is attached to the inner surface of the tunnel panel at a location that is positioned between the first cross-member and the second cross-member.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a schematic illustration of a vehicle including each of an internal combustion engine and battery-powered propulsion system;

FIG. 2 is a lower isometric perspective view of a vehicle frame configured for use in the vehicle illustrated in FIG. 1 having at least one of the internal combustion engine and the battery-powered propulsion system, and having a load-path structure according to a principle of the present disclosure;

FIG. 3 is an upper isometric view of the load-path structure according to a principle of the present disclosure;

FIG. 4 is a lower isometric review of the load-path structure illustrated in FIG. 3;

FIG. 5 is an exploded view of the load-path structure illustrated in FIG. 3;

FIG. 6 is an exploded view of the load-path structure illustrated in FIG. 4;

FIG. 7 is a cross-sectional view along line 7-7 of FIG. 3;

FIG. 8 is a cross-sectional view of the load-path structure, when absorbing and directing a lateral forceful impact; and

FIG. 9 is a cross-sectional view of a conventional vehicle frame that does not include the load-path structure according to a principle of the present disclosure.

Corresponding reference numerals indicate corresponding parts throughout the several views of the drawings.

### DETAILED DESCRIPTION

Example embodiments will now be described more fully with reference to the accompanying drawings. The example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

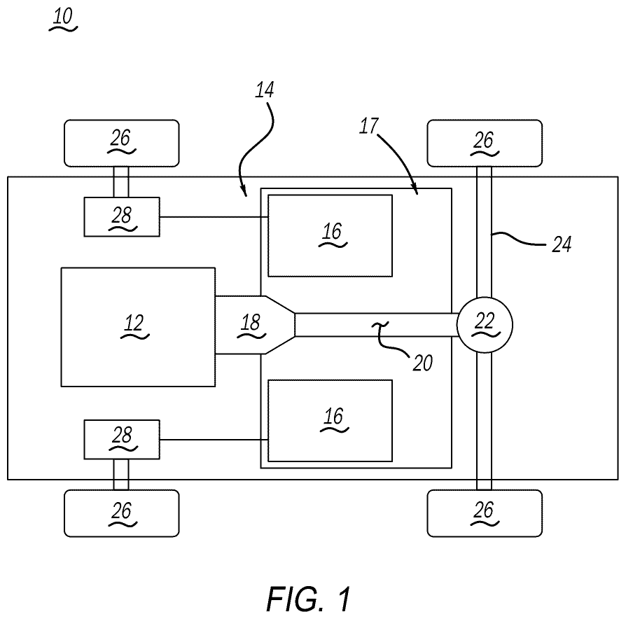

FIG. 1 schematically illustrates a vehicle 10 according a principle of the present disclosure that can be powered by at least one of an internal combustion engine (ICE) 12 and a battery assembly 14. In the illustrated embodiment, battery assembly 14 includes a pair of battery packs 16 that may each include a plurality of battery cells (not shown), and the battery packs 16 are separated to account for a powertrain component 18 (e.g., transmission) attached to ICE 12 that is configured to transfer energy generated by ICE 12 to a drive shaft 20 that extends from powertrain component 18 to a rear differential 22, which in turn transfers the rotational energy of driveshaft 20 to an axle assembly 24 that is configured to drive at least one wheel 26 of the vehicle 10.

In addition, vehicle 10 may include electric drive modules 28 that receive electric power from battery cells 16 of a battery pack 17 (shown in phantom) and are configured to drive at least one of the wheels 26. While electric drive modules 28 are illustrated at each of the front wheels 26 of vehicle 10, it should be understood that each wheel 26 may include a respective drive electric drive module 28, or only the rear wheels 26 may include a respective drive module 28. Further, while ICE 12 is illustrated as being configured to provide power to the rear wheels 26 of vehicle 10 via drive shaft 20, it should be understood that ICE 12 can instead provide power to front wheels 26, if desired and as known in the art.

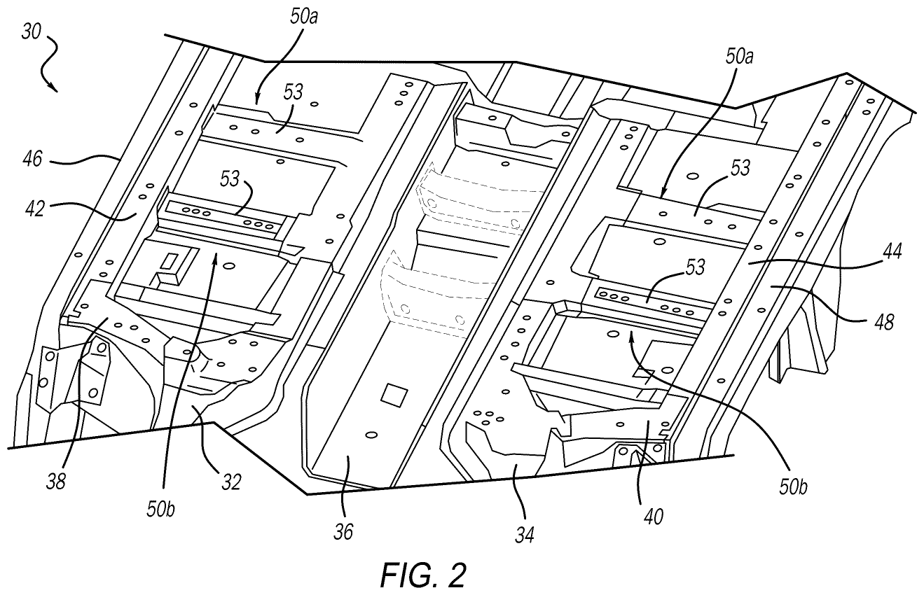

Now referring to FIG. 2, an example frame system 30 that may be used in conjunction with vehicle 10 is illustrated. That is, frame system 30 can be used with vehicle 10 regardless whether vehicle 10 includes an ICE 12 or battery-powered electric drive modules 28. Inasmuch as frame system 30 can be common amongst each of the different propulsion systems, the costs associated with developing a vehicle model can be reduced because separate frame systems do not need to be developed for a respective propulsion system.

Frame system 30 includes a pair of primary frame members 32, 34 that extend longitudinally along a length of vehicle 10. A tunnel panel 36 that is configured to permit drive shaft 20 to pass therethrough is positioned between the primary frame members 32, 34. Primary frame members 32, 34 each include a branch member 38, 40, respectively, that extends outward therefrom before transitioning to a longitudinally extending secondary frame member 42, 44. Battery packs 16 (hidden beneath belly panels 45 in FIG. 2) are respectively positioned between the primary frame members 32, 34 and the second frame members 42, 44. Frame system 30 may also include a pair of sills 46, 48 positioned laterally outward from second frame members 42.

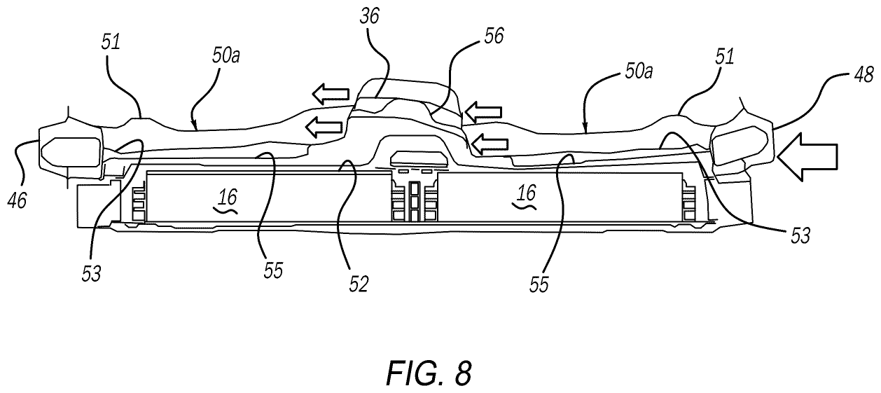

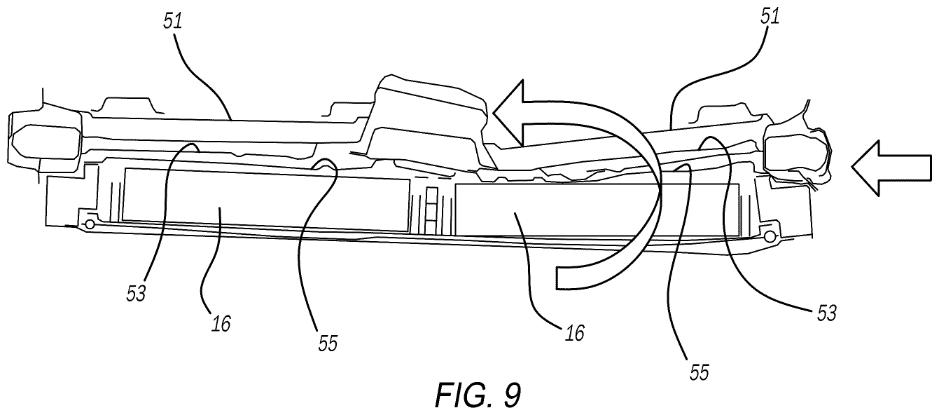

Frame system 30 may also include a plurality of cross-member assemblies 50a and 50b. Cross-member assemblies 50a, 50b assist frame system 30 in absorbing and directing forces exerted laterally on vehicle 10 (i.e., the forces exerted on the vehicle 10 when the vehicle 10 is subjected to a side impact). Put another way, in the event of a lateral impact to one of the sills 46 or 48, the forces will be transferred from the sill 46 or 48 to the cross-member assemblies 50a and 50b, and from the cross-member assemblies 50a and 50b to each of the tunnel panel 36 and one of the primary frame members 32 or 34. If the magnitude of the lateral force is great enough, however, the cross-member assemblies 50a, 50b may deform in a manner that may affect battery packs 16. Cross-member assemblies 50a and 50 each include an upper cross-member 51 and include a lower cross-member 53 (FIG. 2). A floor panel 55 (FIGS. 8 and 9) may be located beneath lower cross-member 53.

More particularly, FIG. 9 illustrates vehicle frame system 30 in the event of a lateral impact thereto. As can be seen in FIG. 9, the force of the impact is of a magnitude that deforms tunnel panel 36 and causes tunnel panel 36 to buckle in a downward direction, which in turn may cause at least one of the cross-member assemblies 50a or 50b to deflect downward toward one of the battery packs 16. The downward deflection of cross-member assemblies 50a, 50b can force floor panel 55 into contact with battery pack 16. While battery packs 16 typically include a housing 52 formed of a rigid material that is resistant to puncture, it is undesirable to expose battery packs 16 any unnecessary forces that could potentially damage the battery pack 16.

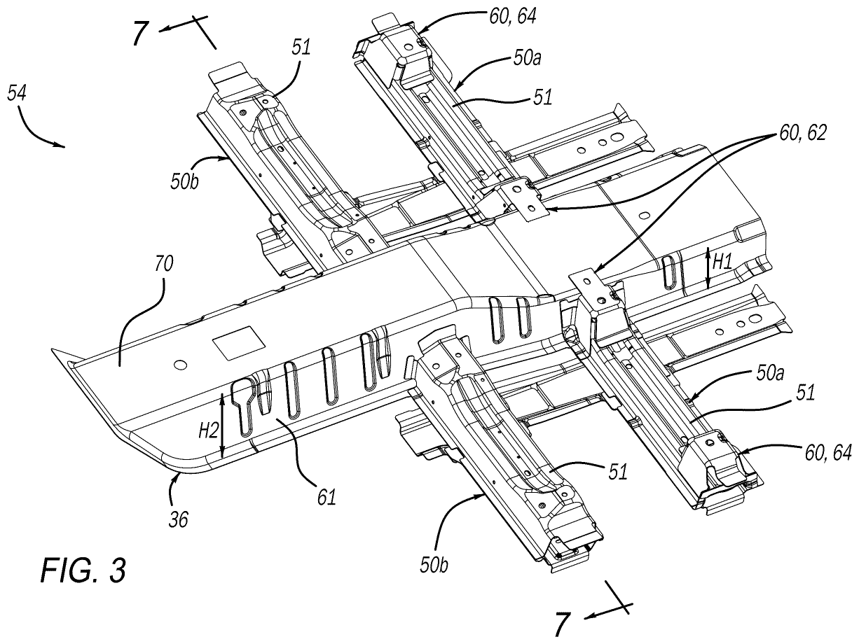

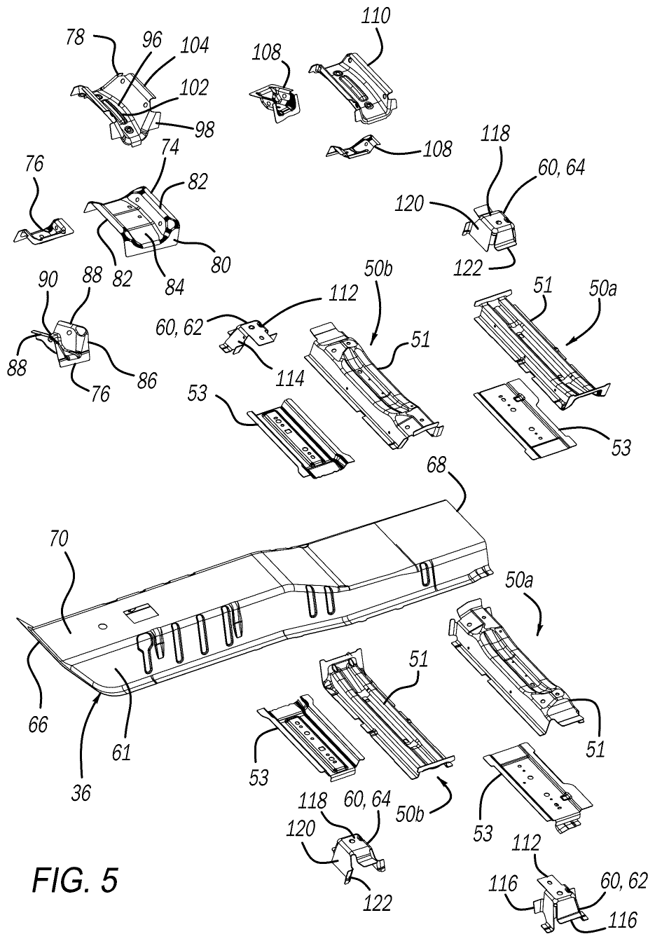

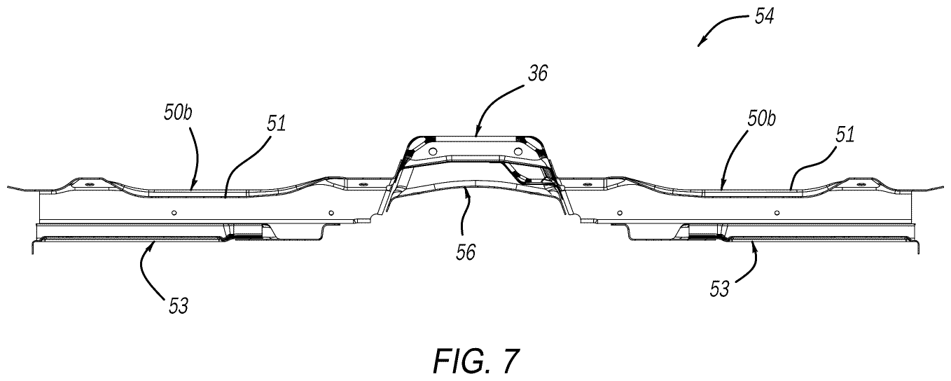

In order to eliminate or at least substantially minimize deformation of cross-member assemblies 50a and 50b that can occur during a side impact to vehicle 10 and potentially risk damage to battery packs 16, the present disclosure provides a load-path reinforcement structure 54 that reinforces cross-member assemblies 50a, 50b and tunnel panel 36, as shown in FIGS. 3-7. Referring to FIGS. 3-7, load-path reinforcement structure 54 includes a first tunnel reinforcement assembly 56 and a second tunnel reinforcement assembly 58 that are each connected to tunnel panel 36 to reinforce tunnel panel 36, and a pair of bracket assemblies 60 that each include a first bracket 62 and a second bracket 64 that can be positioned between tunnel panel 36 and cross-bar member assemblies 50a and between cross-bar member assemblies 50a and one of the sills 46 or 48, respectively. Bracket assemblies 60 are seat mounts, but can assist in transferring forces received by the sills 46, 48 to tunnel panel 36.

While bracket assembly 60 is illustrated as being attached to only a pair of the upper cross-bars 51 of cross-bar member assemblies 50b that are laterally aligned with one another, it should be understood that bracket assembly 60 may be located at either cross-bar member assembly 50a or 50b without departing from the scope of the present disclosure.

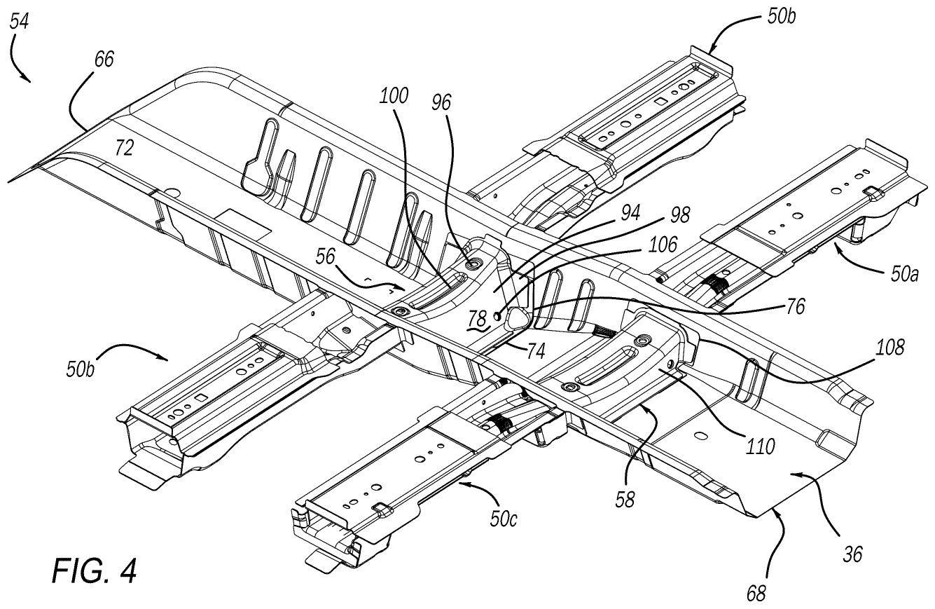

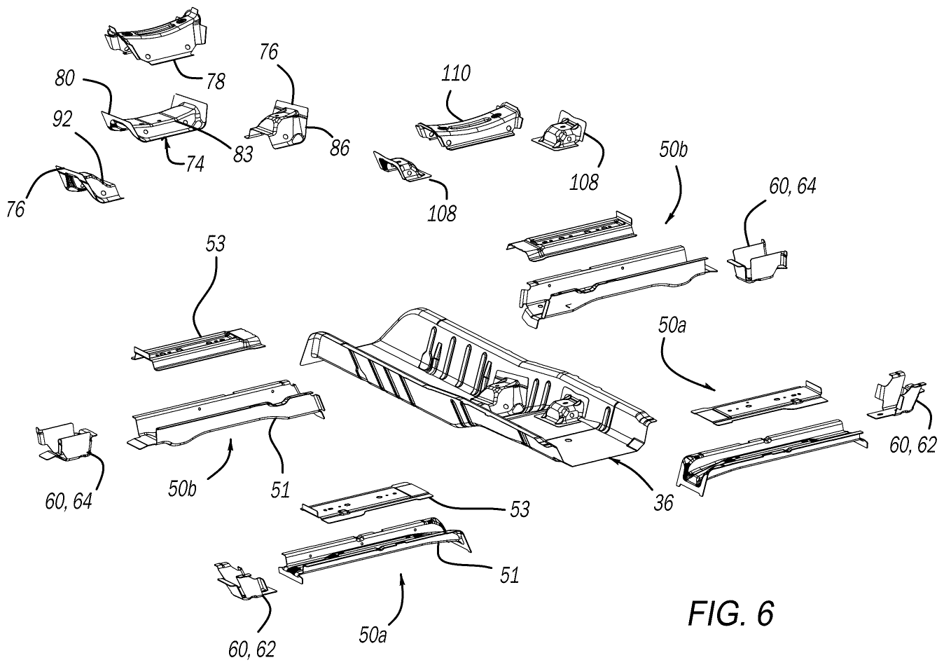

With particular reference to FIGS. 4 and 6, the first and second tunnel reinforcement assemblies 56 and 58 will now be described in detail. Tunnel panel 36 includes a first or forward end 66, an opposite second or rear end 68, an outer surface 70, and an inner surface 72. First and second tunnel reinforcement assemblies 56 and 58 are attached to inner surface 72 and positioned between the first and second ends 66 and 68 of tunnel panel 36 at locations that are aligned with cross-bar members 50a. By aligning first and second tunnel reinforcement assemblies 56 and 58 with cross-bar members 50a, the force of a lateral impact to vehicle 10 can effectively be transferred from cross-members 50a to tunnel reinforcement assemblies 56 and 58 to maintain structural integrity of tunnel panel 36, as will be described in more detail later.

First tunnel reinforcement assembly 56 includes a first reinforcement member 74 attached to inner surface 72, a pair of second reinforcement members 76 that overlap opposing ends of first reinforcement member 74, and a third reinforcement member 78 that overlaps the first reinforcement member 74 and the second reinforcement members 76. First reinforcement member 74 may be formed of a rigid metal material such as steel or aluminum, and extends between and is attached to sidewalls 61 of tunnel panel 36. In this regard, first reinforcement member 74 is a monolithic panel that includes a pair of first flanges 80 that are angled to align and abut with sidewalls 61 of tunnel panel 36. A pair of first rails 82 extend between first flanges 80 that are each configured to abut an upper wall 86 of tunnel panel 36. An opposite side of first rails 82 defines a pocket 83. First rails 82 are interconnected by a first connection section 84 that extends between first rails 82 and between first flanges 80. First reinforcement member 74 may be attached to inner surface 72 of tunnel panel 36 in any manner known to one skilled in the art including welding, brazing, an adhesive, or by using fasteners (not shown).

Second reinforcement members 76 are configured to be attached to opposing ends of first reinforcement member 74. Second reinforcement members 76 are monolithic members that each include a second flange 86 that is angled to align with and abut against one of the first flanges 80 of first reinforcement member 74, and a pair of second rails 88 that are configured to seat within the pockets 83 that are formed opposite the first rails 88. A second connection section 90 extends between and connects second rails 88. Second reinforcement members 76 may include apertures 92 that are configured for receipt of a fastener (not shown) to attached second reinforcement members 76 to first reinforcement member 74. Alternatively, second reinforcement members 76 may be welded, brazed, or adhered to first reinforcement member 74.

Third reinforcement member 78 overlaps second reinforcement members 76 such that second reinforcement members 76 are sandwiched between first reinforcement member 74 and third reinforcement member 78. Third reinforcement member is a monolithic member having a wedge-shaped body including a pair of angled side surfaces 94 that extend along a length of the wedge-shaped body and are connected by a third connection section 96. A plurality outwardly extending third flanges 98 are provided at opposing ends of third connection section 96 and angled side surfaces 94 that are configured to abut against second flanges 86 of second reinforcement members 76. Third connection section 96 may include a recess 100 defining an inwardly (i.e., in a direction toward second reinforcement members 76) ridge 102 that provides increased structural rigidity to third reinforcement member 78. A pair of outwardly extending fourth flanges 104 extend outward from angled side surfaces 94 that are configured to abut against first reinforcement member 74. In addition, angled side surfaces 94 may include apertures 106 that are configured for receipt of a fastener (not shown) that permits third reinforcement member 78 to be fixed to second reinforcement members 76. Alternatively, third reinforcement member 78 may be welded, brazed, or adhered to each of second reinforcement members 76 and first reinforcement member 74.

Second tunnel reinforcement assembly 58 is similar to first reinforcement tunnel assembly 56, but is a three-piece structure rather than the four-piece structure described above. Second tunnel reinforcement assembly 58 includes a pair of first brace members 108 that are substantially similar to second reinforcement members 76, and a second brace member 110 that is substantially similar to third reinforcement member 78. The primary differences between these components are the sizes. A height H1 of the sidewalls 61 of tunnel panel 36 where second tunnel reinforcement assembly 58 is positioned is less than the height H2 of the sidewalls 61 of tunnel panel 36 where first tunnel reinforcement assembly 56 is located, which may require sizing first brace members 108 and second brace member 110 to be smaller. In addition, the lesser height H1 may not permit the use of a brace member that is similar to first reinforcement member 74. The lack of a brace member that is similar to first reinforcement member 74 may be offset by the use of bracket assemblies 60 that are attached to cross-bar members 50a that provided on opposing sides of tunnel panel 36 where second tunnel reinforcement assembly 58 is located.

Bracket assemblies 60 each include a first bracket 62 that is attached to cross-bar member 50a at location proximate tunnel panel 36 and a second bracket 64 that is attached to cross-bar member 50a at a location proximate one of the sills 46 or 48. First brackets 62 include a first connection plate 112 configured to lie overtop and be attached to outer surface 70 of tunnel panel 36 using fasteners, welding, and adhesive or the like. A plurality of first side plates 114 extending downward from first connection plate 112 in a direction toward cross-bar 50a. First side plates 114 may include flanges 116 configured to abut outer surface 70 of tunnel panel 36 and/or cross-bar 50a. Second brackets 64 are substantially similar first brackets 62. Second brackets 64 include a second connection plate 118 and a plurality of second side plates 120 extending downward from second connection plate 118. Second connection plate 118 and second side plates 120 may include flanges 122 configured to abut cross-bar 50a and one of the sills 46 or 48.

Now referring to FIG. 8, operation of load-path reinforcement structure 54 will be described when vehicle 10 is subjected to a side-impact to one of the sills 46 or 48. When a force F is applied to vehicle 10 at one of the sills 46 or 48, the force will be transferred from the respective sill 46 or 48 to the cross-bar member assemblies 50a and 50b. With respect to cross-bar member assembly 50a, a portion of the force will be transferred from the respective sill 46 or 48 to each of the upper cross-bar 51 (force F1) and the lower cross-bar 53 (force F2).

The upper and lower cross-bars 51 and 53 will then transfer the forces F1 and F2, respectively, to the tunnel panel 36. As shown in FIG. 9, the transfer of these forces would typically cause the tunnel panel 36 to buckle in a direction toward floor panel 55, which could force floor panel 55 in a direction toward battery pack 16. The configuration shown in FIG. 8, however, includes the first and second tunnel reinforcement assemblies 56 and 58 that provide structural reinforcement to the tunnel panel 36 and permit the forces F1 and F2 to be transferred from the cross-bar member assemblies 50a and 50b to the first and second tunnel reinforcement assemblies 56 and 58, before being transferred to the opposing cross-bar member assemblies 50a and 50b located on the side of the vehicle 10 opposite to the original impact. By this time, the forces F1 and F2 will have diminished to an extent that deformation (if any) of the opposing cross-bar member assemblies 50a and 50b can be avoided or at least substantially minimized. Regardless, the important aspect to keep in mind is that the first and second tunnel reinforcement assemblies 56 and 58 maintain structural integrity of the tunnel panel 36 to prevent or at least substantially minimize buckling of the tunnel panel 36 in a direction toward the floor panel 55 to avoid floor panel 55 from being forced in a direction toward battery pack 16.

It should be understood that if vehicle 10 includes ICE 12, the load-path reinforcement assembly 54 may be unnecessary. In this regard, if vehicle 10 includes ICE 12 the vehicle 10 will not include battery packs 16 and, therefore, if tunnel panel 18 were to buckle during a side impact to vehicle 10, there would be no risk to damaging such a component. In addition, tunnel panel 36 may carry at least a portion of powertrain component 18 and drive shaft 20 to differential 22 and the load-path reinforcement assembly 54 would interfere with routing of these components through tunnel panel 36.

Nonetheless, it should be understood that the same frame assembly 30 can be used on either type of vehicle 10 regardless of the propulsion system and during manufacture of the vehicle 10 when it is decided which propulsion system will be used in the vehicle 10, a decision can be made whether to install load-path reinforcement assembly 54 in its entirety (i.e., when vehicle 10 is powered by an electric propulsion system) or at least partially (i.e., it should be understood that if vehicle 10 includes ICE 12, vehicle 10 may still include reinforcement assembly 54 but various features of reinforcement assembly 54 that would interfere with drive shaft 20 such as third reinforcement member 78 and second brace member 110 can be omitted). In either case, because at least a majority of the same frame assembly 30 can be used on either vehicle 10, the overall costs associated with developing each of the battery-powered vehicle 10 and the ICE-powered vehicle 10 can be reduced because at least a majority of the frame system 30 will essentially be common between the vehicles 10.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A vehicle comprising:
a propulsion system including at least one battery pack;
a frame system configured to support the at least one battery pack, the frame system including:
a pair of primary frame members that each longitudinally extend along at least a portion of a length of the vehicle,
a pair of sills that are positioned laterally outward from the pair of primary frame members and longitudinally extend along at least the portion of the length of the vehicle,
a first cross-member, a second cross-member, a third cross-member, and a fourth cross-member that each extend between a respective sill and a respective primary frame member, the first to fourth cross-members being configured to direct energy received by the respective sill during a side-impact to the vehicle to the respective primary frame member, and
a tunnel panel that longitudinally extends along the pair of primary frame members and connects the pair of primary frame members; and
a load path reinforcement system that reinforces the first to fourth cross-members and the tunnel panel during the side-impact to the vehicle, the load path reinforcement system including:
at least one tunnel reinforcement assembly configured to maintain structural integrity of the tunnel panel during the side-impact to the vehicle, and
a plurality of bracket assemblies that each include a first bracket and a second bracket, one of the first brackets being positioned between the tunnel panel and the first cross-member and another of the first brackets being positioned between the tunnel panel and the second cross-member, one of the second brackets being positioned between the first cross-member and one of the sills, and another of the second brackets being positioned between the second cross-member and the one of the sills,
wherein the at least one battery pack is provided between one of the primary frame members and one of the sills, and
the load path reinforcement system is configured to direct the energy received by the respective sill during the side-impact to the vehicle to prevent or at least minimize the tunnel panel and cross-members from deforming and contacting the battery pack during the side-impact to the vehicle.

2. The vehicle according to claim 1, wherein the tunnel panel includes a first end, an opposite second end, an upper wall that extends the first end and the opposite second end, pair of sidewalls connected to the upper wall that extend between the first end and an opposite second end, an outer surface, and an inner surface.

3. The vehicle according to claim 2, wherein the at least one tunnel reinforcement assembly includes a first tunnel reinforcement assembly having a first reinforcement member attached to the inner surface of the tunnel panel, a pair of second reinforcement members that overlap opposing ends of the first reinforcement member, and a third reinforcement member that overlaps the first reinforcement member and the second reinforcement members.

4. The vehicle according to claim 3, wherein the first tunnel reinforcement assembly is attached to the inner surface of the tunnel panel at a location that is positioned between the third cross-member and the fourth cross-member.

5. The vehicle according to claim 3, wherein the first reinforcement member extends between and is attached to the sidewalls of the tunnel panel by a pair of first flanges that are angled to align and abut with the sidewalls of the tunnel panel, a pair of first rails extend between the first flanges that are each configured to abut the upper wall of the tunnel panel, and an opposite side of the first rails defines a pocket.

6. The vehicle according to claim 5, wherein the second reinforcement members each include a second flange that is angled to align with and abut against one of the first flanges of the first reinforcement member, and a pair of second rails that are configured to seat within the pockets that are formed opposite the first rails of the first reinforcement member.

7. The vehicle according to claim 6, wherein the third reinforcement member overlaps the second reinforcement members such that second reinforcement members are sandwiched between first reinforcement member and the third reinforcement member, the third reinforcement member having a wedge-shaped body including a plurality of outwardly extending third flanges that are provided at opposing ends of the wedge-shaped body that are configured to abut against the second flanges of the second reinforcement member, and a pair of outwardly extending fourth flanges that extend outward from angled side surfaces of the wedge-shaped body that are configured to abut against the first reinforcement member.

8. The vehicle according to claim 7, wherein the third reinforcement member is at least one of welded, brazed, adhered, or fastened to each of the second reinforcement members and the first reinforcement member.

9. The vehicle according to claim 3, wherein the at least one tunnel reinforcement assembly includes a second tunnel reinforcement assembly having a pair of first brace members that are attached to the inner surface of the tunnel panel, and a second brace member that overlaps the pair of first brace members.

10. The vehicle according to claim 9, wherein the second tunnel reinforcement assembly is attached to the inner surface of the tunnel panel at a location that is positioned between the first cross-member and the second cross-member.

11. A method of manufacturing a vehicle, comprising:
providing a frame system including a pair of sills, a tunnel panel provided between the pair of sills, and a plurality of cross-bar member assemblies between each of the sills and the tunnel panel;
determining whether the vehicle will be electrically powered by a battery pack or powered by an internal combustion engine; and
after determining whether the vehicle will be electrically powered or power powered by an internal combustion engine, determining whether to install a load-path reinforcement system on the tunnel panel to reinforce the tunnel panel in the event of a side impact to the vehicle,
wherein the load-path reinforcement system is installed on the tunnel panel when the vehicle is electrically powered and includes the battery pack.

12. The method according to claim 11, wherein
the plurality of cross-bar member assemblies includes a first cross-member, a second cross-member, a third cross-member, and a fourth cross-member that each extend between a respective sill and the tunnel panel, the first to fourth cross-members being configured to direct energy received by the respective sill during a side-impact to the vehicle to the tunnel panel, and
the load path reinforcement system includes:
at least one tunnel reinforcement assembly configured to maintain structural integrity of the tunnel panel during the side-impact to the vehicle, and
a plurality of bracket assemblies that each include a first bracket and a second bracket, one of the first brackets being positioned between the tunnel panel and the first cross-member and another of the first brackets being positioned between the tunnel panel and the second cross-member, one of the second brackets being positioned between the first cross-member and one of the sills, and another of the second brackets being positioned between the second cross-member and the one of the sills,
wherein the battery pack is provided between the sills, and
the load path reinforcement system is configured to direct the force received by the respective sill during the side-impact to the vehicle to prevent or at least minimize the tunnel panel and cross-members from deforming and contacting the battery pack during the side-impact to the vehicle.

13. The method according to claim 12, wherein the tunnel panel includes a first end, an opposite second end, an upper wall that extends the first end and the opposite second end, pair of sidewalls connected to the upper wall that extend between the first end and an opposite second end, an outer surface, and an inner surface.

14. The method according to claim 13, wherein the at least one tunnel reinforcement assembly includes a first tunnel reinforcement assembly having a first reinforcement member attached to the inner surface of the tunnel panel, a pair of second reinforcement members that overlap opposing ends of the first reinforcement member, and a third reinforcement member that overlaps the first reinforcement member and the second reinforcement members.

15. The method according to claim 14, wherein the first tunnel reinforcement assembly is attached to the inner surface of the tunnel panel at a location that is positioned between the third cross-member and the fourth cross-member.

16. The method according to claim 14, wherein the first reinforcement member extends between and is attached to the sidewalls of the tunnel panel by a pair of first flanges that are angled to align and abut with the sidewalls of the tunnel panel, a pair of first rails extend between the first flanges that are each configured to abut the upper wall of the tunnel panel, and an opposite side of the first rails defines a pocket.

17. The method according to claim 16, wherein the second reinforcement members each include a second flange that is angled to align with and abut against one of the first flanges of the first reinforcement member, and a pair of second rails that are configured to seat within the pockets that are formed opposite the first rails of the first reinforcement member.

18. The method according to claim 17, wherein the third reinforcement member overlaps the second reinforcement members such that second reinforcement members are sandwiched between first reinforcement member and the third reinforcement member, the third reinforcement member having a wedge-shaped body including a plurality of outwardly extending third flanges that are provided at opposing ends of the wedge-shaped body that are configured to abut against the second flanges of the second reinforcement member, and a pair of outwardly extending fourth flanges that extend outward from angled side surfaces of the wedge-shaped body that are configured to abut against the first reinforcement member.

19. The method according to claim 14, wherein the at least one tunnel reinforcement assembly includes a second tunnel reinforcement assembly having a pair of first brace members that are attached to the inner surface of the tunnel panel, and a second brace member that overlaps the pair of first brace members.

20. The method according to claim 19, wherein the second tunnel reinforcement assembly is attached to the inner surface of the tunnel panel at a location that is positioned between the first cross-member and the second cross-member.
